(19) United States
(12) Patent Application Publication
(10) Pub. No.: US 2007/0096535 A1
(43) Pub. Date: May 3, 2007

(54) RESTRAINT SYSTEM FOR A VEHICLE

(75) Inventors: Bjorn Lundell, Goteborg (SE); Per Gyllenspetz, Goteborg (SE); Par-Erik Krans, Goteborg (SE)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/163,906

(22) Filed: Nov. 3, 2005

(51) Int. Cl. B60R 21/18; B60R 21/013; B60R 21/015; B60R 22/00

(52) U.S. Cl. 297/470; 297/468; 297/472; 297/471; 297/216.1

(57) ABSTRACT

A restraint system for use in a passenger seating area of a motor vehicle includes a seat belt assembly disposed adjacent the passenger seating area which is adjustable between a stowed position and at least one deployed position. The seat belt assembly including a webbing positionable across the body of an occupant and an inflatable section disposed within the webbing adjustable between a deflated condition and an inflated condition by a source of gas pressure. An anchor is disposed opposite the seat belt assembly adjacent the seating area and includes a receiving element adapted to engage and secure the belt assembly. A controller monitors vehicle conditions and is operative to inflate the inflatable section such that the belt assembly is placed in a deployed position for securement around an occupant in a vehicle.

### BACKGROUND OF THE INVENTION

1. Field of the Invention

The present invention relates generally to occupant restraint systems used in motor vehicles, and more specifically to a restraint system incorporating a presenter making it easier for an occupant to grasp and secure the belt.

2. Background Art

Occupant restraint belt systems (also known as seat belts) are fitted to most types of passenger vehicles in order to protect vehicle occupants from injury during a crash or other abrupt deceleration of the vehicle. One limitation to the effectiveness of modern seat belts is that they require a voluntary and optional act by the occupant to fasten the belt properly around their body. Some persons do not use their vehicle's seat belts because they find it difficult or inconvenient to don the seat belt.

This difficulty in donning the belt is sometimes due to the fact that when the belt is in the unfastened condition, it must assume a stowed position in which it does not obstruct the occupant while entering or exiting the vehicle. Consequently, the seat belt is typically configured so that it is pulled to the rear by a retractor mechanism. With the belt in this stowed position, portions of the belt that the occupant must grasp in order to don the belt may be difficult to see and/or reach when in the seated position.

Systems have been proposed for moving a seat belt inwardly and/or forwardly to a more easily grasped position after the occupant is seated in the seat. Examples of such systems are disclosed in U.S. Pat. Nos. 6,550,805 and 6,676,612, which are hereby incorporated by reference. It would be advantageous to provide a restraint system for a vehicle seating area which includes a belt presentation and securement system which assists the user in securing the belt while seated in the vehicle seat.

### SUMMARY OF THE INVENTION

The present invention provides a restraint system for use in a passenger seating area of a motor vehicle. The restraint system includes a seat belt assembly disposed adjacent the passenger seating area which is adjustable between a stowed position and at least one deployed position. The seat belt assembly including a webbing positionable across the body of an occupant extending between a lower anchor mounted adjacent a lower side portion of the seat and a belt retractor disposed adjacent an upper side portion of the seat.

An inflatable section disposed within the webbing for presenting the belt assembly is adjustable between a deflated condition and an inflated condition by a source of gas pressure. The gas pressure source is operable to alternatively inflate and deflate the inflatable section. An anchor is disposed opposite the seat belt assembly adjacent the seating area and includes a receiving element adapted to engage and secure the belt assembly.

A controller monitors vehicle conditions with one or more sensors. The controller instructs the source of gas pressure to inflate the inflatable section, which positions the belt assembly in a deployed position for grasping by the occupant and/or securement around an occupant in a vehicle when the controller receives a signal from the one or more sensors indicating a change in vehicle conditions.

Other features and advantages of the present invention will be readily appreciated and better understood after reading the subsequent description when considered in connection with the accompanying drawings.

### BRIEF DESCRIPTION OF THE DRAWINGS

FIG. 1 is a side view of a restraint system for use in a passenger seating area of a motor vehicle in accordance with the present invention;

FIG. 2 is a perspective view of the restraint system in combination with a vehicle seat of the present invention;

FIG. 3 is a front plan view of the vehicle seating area with the restraint system in a stowed position;

FIG. 4 is a perspective view of the vehicle seating area with the restraint system in an activated or deployed position;

FIG. 5 is a perspective view of the vehicle seating area with the restraint system in a secured position;

FIG. 6 is a schematic view of the restraint system in accordance with the present invention;

FIG. 7 is a cross-sectional view of the belt assembly with the inflatable section in a deflated condition;

FIG. 8 is a cross-sectional view of the belt assembly with the inflatable section in an inflated condition;

FIG. 9 is a cross-sectional view of the belt assembly of the restraint system having an inflatable section in accordance with a second aspect of the present invention; and

FIG. 10 is a cross-sectional view of the belt assembly of the restraint system having an inflatable section in accordance with a third aspect of the present invention.

### DETAILED DESCRIPTION OF THE PREFERRED EMBODIMENT(S)

Referring now to the Figures, a restraint system incorporating a belt presenter in accordance with the present invention is shown installed in a vehicle having a seating area. It is understood that the restraint system may be used in either the front or rear passenger seating areas. For purposes of this disclosure, the restraint system will be installed in the front passenger seating area.

Restraint system 10 includes an associated seat belt assembly 12 incorporated in or disposed adjacent to a vehicle seat 14 or seating area. Vehicle seat 14 is of the type well known in the art. Seat 14 includes a generally upright seat back 16 for supporting the torso of a seated occupant 18 (indicated in phantom lines) and a generally horizontal seat bottom or cushion 20 projecting generally upward and forward from the bottom portion of the seat back 16 for supporting the pelvis and thighs of the occupant 18.

For purposes of description only, the vehicle seat 14 will be referred to herein as having an inboard side and an outboard side, these terms referring to the sides of the seat adjacent to a center of a vehicle and an exterior side of a vehicle respectively, as is the case if the seat is located on the left side of the vehicle. This disclosure applies equally to a seat located at any position within a vehicle.

The belt assembly 12 comprises a length of flexible webbing 22 having an upper end secured to an upper anchor 24 adjacent the upper outboard portion 26 of the seat back 16, and a lower end secured to a lower anchor 28 adjacent the rear portion of the seat bottom 20. Webbing 22 serves as a main restraint member and includes an inflatable section (not shown) which will be described in greater detail below.

When the webbing 22 is inserted over and secured to a buckle or receiving element 30 extending from an anchor 32, the webbing 22 defines a lap belt and a shoulder belt in a manner well known in the art to restrain the occupant 18 in the event of a crash or other abrupt deceleration of the vehicle. For purposes of description, anchor 32 is shown inboard of the vehicle seat. However, it is understood that the anchor may be positioned inboard or outboard in the three, four or five point belt assemblies.

As an alternative, the lap belt and shoulder belt may be formed as separate lengths of webbing connected by a fitting (not shown) that includes a receiving element engageable with the inboard anchor. It is also contemplated that belt restraint system 10 may be used with a three point, four point or five point belt assembly.

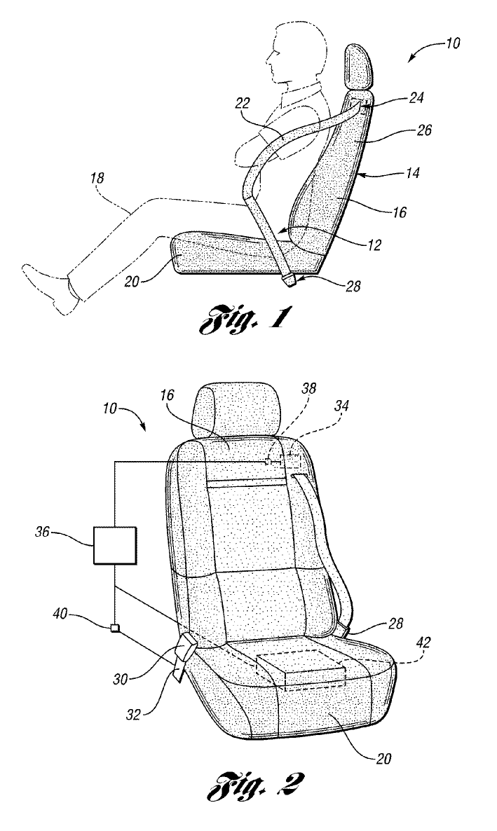

The upper anchor 24 preferably comprises a belt retractor 34 that may be housed within seat back 16 (as shown in FIGS. 1 and 2), or mounted to a portion of the vehicle structure such as a roof rail or B-pillar as is shown in FIGS. 3-5 and as is well known in the restraints art. The belt retractor 34, operative to retract the webbing 22 when it is not fastened about the occupant 18, provides for adjustment of the length of the belt for varying-sized seat occupants, and properly positions the seat belt restraint system as is well known in the art.

The belt retractor 34 may include load limiter and/or belt pretensioner devices (not shown) of the type well known in the restraints art. In one aspect of the present invention, belt retractor 34 includes an electric motor which assists in the deployment of belt assembly 12. The belt retractor 34 tensions the belt when a spring force is exceeded in response to detection of a possible accident condition, such as vehicle deceleration, which causes the belt to spool out from the retractor. The electric motor, in response to a signal from the controller, automatically spools out webbing as the belt is inflated to overcome the spring force designed into retractor 34 to allow the belt to be presented to a deployed position. The motor may also assist the retractor when retracting the webbing on to the spool.

Referring now to FIGS. 2 and 6, the restraint system 10 includes a controller 36 that monitors the condition of the seat belt assembly 12. One or more sensors 38, 40, 42 are disposed adjacent various portions of the passenger seating area or vehicle seat, including the belt retractor 34 and receiving element 30. Sensors 38, 40, 42 are configured to monitor the condition of the belt assembly 12 and receiving element 30, as well as the occupancy of the vehicle seat 14.

In a preferred aspect of the present invention, sensor 38 monitors the state of belt retractor 34 to determine whether webbing 22 is drawn from a spooled condition in retractor 34 to a use position. Sensor 38 may detect the condition of belt retractor using a variety of sensing methods. For example, a sensor may be incorporated into the belt retractor to detect rotational movement of the retractor. Alternatively, a photocell may be disposed adjacent the belt retractor to sense when the webbing is spooled out from the retractor. In another embodiment, a microswitch senses a change in the diameter of the spooled belt, such that a decrease in diameter indicates a change in condition.

Sensor 40 is provided adjacent the receiving element 30 to detect the presence of the webbing 22 placed around the receiving element 30 for securement. It is understood that the controller 36 may monitor conditions of the seat 14 through the use of sensor 42 coupled to other vehicle systems, such as a seat weight sensor, a door status indicator switch, a buckle status switch, combined with or integrated into a pressure bladder and an ignition switch. For example, the controller may transmit a signal to inflate the inflating portion of the seat belt in response to a “seat occupied” indication from seat weight sensor, and/or a “door closed” indication from door condition sensor, and/or in response to an “on” indication from ignition key.

Referring now to FIGS. 3-8, a description of the belt presentation features of the restraint system of the present invention is described in greater detail. As is illustrated in FIG. 3, prior to an occupant being seated in seat 14, the belt assembly is placed in a stowed position or first position, in which the belt is unfastened and belt retractor (not shown) draws webbing 22 upward so that it extends in a substantially straight line between the upper and lower anchors.

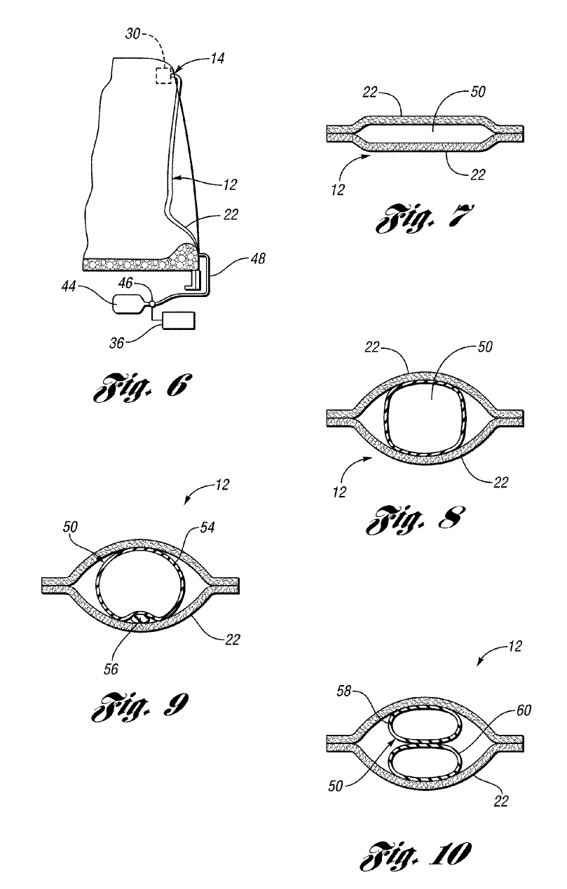

In this position, as shown in FIGS. 3 and 7, the inflatable section 50 of the belt assembly is in a deflated condition such that the belt is in the stowed position wherein the belt is unfastened and offers little or no interference with the seat occupant entering or exiting the vehicle. In the deflated condition, the inflatable section in webbing 22 does not significantly affect the flexibility of the belt assembly 12.

Receiving element 30 connected to the anchor 32 is disposed adjacent the seat bottom 20. Receiving element 30 is configured to receive and secure webbing 22 in a secured position. It is contemplated that receiving element 30 may include a buckle element which receives and secures a latch element disposed as the webbing of the belt assembly.

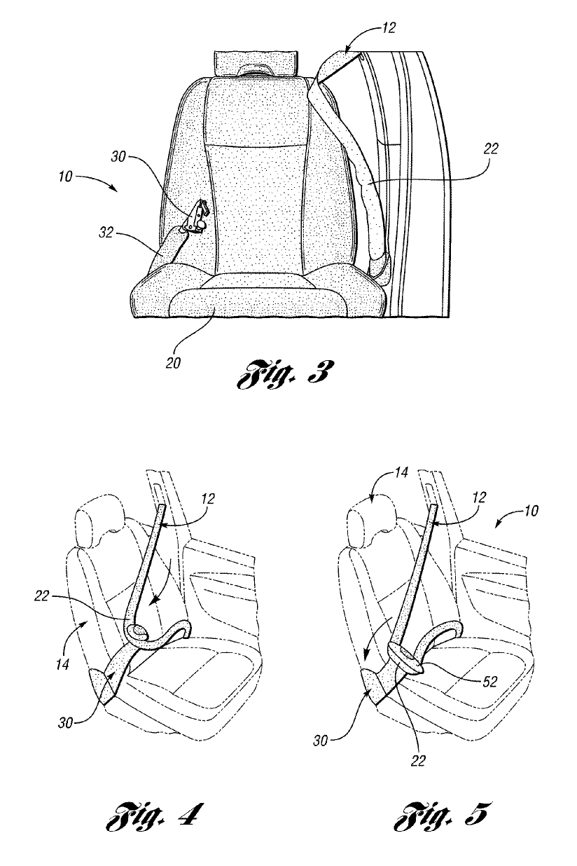

As is illustrated in FIG. 4, webbing 22 of belt assembly 12 is shown extending at least partially across vehicle seat 14 toward receiving element 30 in an activated or deployed position. The controller 36, as shown in FIG. 6, in response to a signal output from one or more of sensors 38, 40, 42, transmits a signal to a pressure source, shown as block 44. Pressure source 44 may be located anywhere on board the vehicle and preferably comprises a pressure vessel that is recharged by an air compressor (not shown). Alternatively, the pressure source may comprise a vehicle component which supplies pneumatic power to other vehicle systems such as an air suspension system (not shown).

In yet another aspect of the present invention, a pressure bladder (not shown) may be disposed within the seat cushion and contain air or another gas. When an occupant sits on seat cushion, the pressure bladder is compressed by the occupant's body weight, and at least a portion of the gas contained in the bladder is forced into inflatable section, causing the belt assembly to move to the deployed condition.

Referring now to FIGS. 6-8, a description of the interconnection between an inflatable section 50 in webbing 22 of seat belt assembly 12 and the pressure source 44 is described in greater detail. A valve 46 may be provided to control the flow of gas from the pressure source 44 into a hose 48. Controller 36 monitors and controls pressure source 44 and/or valve 46 to control the flow of pressurized gas from the pressure source through hose 48 into the inflatable section 50 of belt assembly 12.

Controller 36 activates pressure source 44 and/or valve 46 so as to force gas through hose 48 and into inflatable section 50 after the occupant is seated in the vehicle seat and ready to don the seat belt. The controller may, for example, inflate the belt assembly in response to a “seat occupied” indication from a seat weight sensor, and/or a “door closed” indication from door condition sensor, and/or in response to an “on” indication from ignition key. It is also contemplated that the controller will instruct the valve to allow the inflatable section 50 to deflate upon detection of a secondary condition, such as a period of time elapsing without use of the restraint system, or detection of a “door open” indication from the door condition sensor or an “off” indication from the ignition key.

As shown in FIG. 8, when inflatable section 50 inflates to present the belt to the occupant, it expands in cross-section so that it is no longer flat and, as a result, becomes substantially more rigid than when deflated. In the deployed condition shown in FIG. 4, the inflatable section in webbing 22 causes belt assembly 12 to extend generally forward and inward with respect to the seat 14 and occupant so that the occupant may grasp webbing 22, pull the belt across his/her body, and secure the webbing 22 to receiving element 30 on the anchor. Movement of the belt to the deployed, graspable condition may require some amount of the webbing 22 to be drawn out of retractor 34, so inflation of inflatable section 50 must provide sufficient force to overcome the winding force of the retractor. Alternatively, use of an electric motor with the retractor assists in feeding webbing when the inflatable section is inflated to overcome the spring force of the belt retractor and retracting the webbing in the deflated condition.

In the deployed condition, belt assembly 12 is preferably adjacent or above the upper surface of the occupant's thigh and far enough forward and inward for the occupant to easily see and grasp the webbing 22. The inflatable section remains somewhat flexible and compliant when in the inflated condition so that it does not cause any discomfort to occupant if it contacts the occupant's body as it extends inward to present the belt. If, due to the geometry of the vehicle seat, anchors, or other vehicle structure, the inflatable section must assume a complicated shape in order to properly position the belt in the deployed condition. This may be achieved by designing the inflatable section to include a variety of shapes and geometries, which will be described in greater detail below.

Referring now to FIG. 5, belt assembly 12 of restraint system 10 is shown in the secured position. It is contemplated that belt assembly 12 may be secured around receiving element 30 with or without the aid of the seat occupant. In a first aspect of the present invention, when the inflated section in webbing 22 inflates, the belt assembly extends at least partially across the occupant's body towards the receiving element 30. The seat occupant grasps webbing 22 and places the webbing 22 over receiving element 30. Receiving element 30 may comprise an anchor that includes a locking element to secure webbing. Alternatively, the receiving element may include a fixed tether with one or more protruding sections which are designed to engage and secure the webbing.

In one aspect of the present invention, the sensor positioned adjacent receiving element 30 detects the presence of the webbing 22 and transmits a signal to the controller. Controller, in response to this signal, commands the valve to open, thereby deflating inflatable section. When the inflatable section at least partially deflates, the belt assembly 12 will secure the occupant within the vehicle seat 14. It is also contemplated that the controller will instruct the pressure source and/or valve to deflate the inflatable section in the webbing 22 based on the detection of other conditions, including the belt retractor sensor detecting the occupant grasping the belt assembly, expiration of a set time period, or by any other appropriate condition or combination of conditions of vehicle systems.

In another aspect of the present invention, the belt assembly 12 may inflate and extend around the receiving element 30 during the inflation process. During this process, the inflatable section fills and expands the webbing such that the webbing extends across the occupant in seat 14 such that the webbing inflates over the receiving element adjacent a locking element 52. Once positioned in locking element 52, the controller will transmit a signal to the pressure source and/or valve to at least partially deflate the inflatable section in webbing 22 to secure the occupant in vehicle seat 14.

Referring now to FIGS. 7-10, a more detailed description of belt assembly 12 of restraint system 10 is provided. The inflatable section 50 of webbing 22 is attached to the lower anchor of the restraint system. The inflatable section 50 in the inflated condition has an expanded circular shape in cross-section and is more rigid than when in the deflated condition and urges the belt assembly to the at least one deployed position in which the belt is unfastened and is positioned so that the seat occupant may easily grasp the belt to permit fastening of the belt, as shown in FIG. 4. It is understood that the inflatable section may be positioned anywhere along the length of the belt, including adjacent an upper belt anchor. An inflatable section disposed adjacent an upper anchor will move so that its lower end moves forward and/or inward when it deploys.

In the deflated condition shown in FIG. 7, inflatable section 50 and webbing 22 are positioned adjacent one another. In a preferred aspect of the present invention, As shown in FIG. 8, inflatable section 50 when inflated has a cross section circumference which is significantly less than that of the surrounding webbing. This difference in width allows inflatable section 50 to freely expand to a generally circular shape in cross-section and to a generally curved shaped longitudinally within the webbing 22 while allowing the webbing 22 to maintain sufficient flexibility to extend from the stowed position to a deployed position.

The inflatable section of the belt assembly can be formed by a variety of materials and manufacturing methods. As shown in FIGS. 7-8, webbing 22 of belt assembly 12 is formed from a pair of woven strips which are stitched or otherwise secured together to form a recess to receive the inflatable section 50. The inflatable section 50 is formed from a flexible, impermeable material, such as polyvinyl carbonate (PVC) or polyester. Inflatable section is preferably formed as a pair of strips that are sealed or secured to each other with adhesive or the like to allow for expansion of the material and provide a substantially gas-tight inner chamber. When expanded, the inflation section 50 provides webbing 22 a curved shape optimal for securement to a receiving element provided on the opposite side of the vehicle seat.

Referring now to FIGS. 9 and 10, alternative embodiments of the inflatable section 50 of the present invention are shown and disclosed. FIG. 9 illustrates a inflatable section 50 disposed within a webbing 22 of seat belt assembly 12. Inflatable section 50 includes an inflatable member 54 secured to a structural member 56. Inflatable member 54 is preferably a one-piece elastic tube which forms an inner chamber therein. Structural member 56 may comprise a polymeric chord which can be either laminated or attached to a portion of the inflatable member 54. In one aspect of the present invention, the inflatable member 54 inflates to a generally curved shape such that the structural member 56 is longitudinally shorter than the webbing 2 while maintaining more rigidity than webbing 22. It is also understood that the inflatable member may be shaped based on the amount and application of air pressure entering the inner chamber.

As shown in FIG. 10, the inflation chamber of inflatable section 50 need not be one large, tubular section, but instead may be divided into multiple sections. Inflatable section 50 comprises a pair of inflatable tubes 58, 60, each defining an inner chamber therein. Tubes 58, 60 are laminated together to form inflatable section 50 within webbing 22 of seat belt assembly 12. The longitudinal curved shape of inflatable section 50 is preferably controlled by application of different pressures in each tube by the pressure source. Alternatively, tubes 58, 60 may have distinct elastic properties, allowing one tube to expand into the webbing, allowing the belt to deploy, while the remaining tube retains the desired curved shape. It is understood that tubes 58, 60 may be separated from one another, or they may be connected with one another to permit some amount of gas flow between them.

Alternatively, it is also possible to fabricate a belt according to the invention wherein the inflatable section is formed integrally with the webbing. This may be accomplished, by manufacturing the webbing as a flat, two-layer, tubular structure in, for example, a “one-piece woven” technique. This type of construction eliminates the need to stitch a separate top layer to the webbing. The upper end of the inflation chamber is defined by stitching or otherwise sealing off the chamber so that the portion of the belt above the stitching does not inflate.

The webbing should be manufactured to naturally maintain a flat condition. It is also possible to fabricate the inflatable section as a unit that is separate from webbing, and that is subsequently secured to the webbing. This may be achieved, for example, by fabricating a flexible tube (not shown) with closed ends that is sewn or otherwise secured to webbing in the desired location to define inflatable section.

It is also possible for an inflatable section according to the present invention to be maintained in a state of partial inflation at times when it is desired that the belt be in the stowed condition. Inflatable section will be configured such that the partially inflated state gives belt a shape and a degree of rigidity that serves (along with the belt tension provided by belt retractors) to help retain the belt in the desired stowed condition in which it will not interfere with occupants entering and exiting the vehicle. The state of partial inflation may constitute inflation of the same inflation chamber or group of chambers that are used to achieve deployment, but at a reduced pressure. Or the state of partial inflation may constitute inflation of an inflation chamber or a group of chambers separate from those used to achieve deployment. In either case, the controller is programmed to supply pressure to inflatable section in a manner to achieve the partially inflated state at desired times based on inputs from appropriate vehicle systems.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A restraint system for use in a passenger seating area of a motor vehicle, the restraint system comprising:
a seat belt assembly disposed adjacent the passenger seating area adjustable between a stowed position and at least one deployed position, the seat belt assembly including a webbing positionable across the body of an occupant;
an inflatable section disposed within the webbing having a deflated condition and an inflated condition wherein the belt assembly is urged to the at least one deployed position;
an anchor disposed opposite the seat belt assembly adjacent the seating area having a receiving element adapted to engage and secure the belt assembly; and
a controller operative to monitor vehicle conditions,
wherein the inflatable section inflates to position the belt in the at least one deployed position for securement around an occupant in a vehicle when the controller detects occupancy of the vehicle seat.

2. The system of claim 1 wherein the webbing of the seat belt assembly extends between a lower anchor mounted adjacent a lower side portion of the seat and an upper anchor including a belt retractor disposed adjacent an upper portion of the seat.

3. The system of claim 1 wherein the inflatable section in the deflated condition has a generally flat cross-section, and in the inflated condition has an expanded cross-section and is more rigid than when in the deflated condition and urges the belt assembly to the at least one deployed position in which the belt is unfastened and is positioned so that the seat occupant may easily grasp the belt to permit fastening of the belt.

4. The system of claim 3 wherein the inflatable section in the inflated condition has a cross-section that is smaller than that of the surrounding webbing and is at least partially curved in shape as it extends generally longitudinally through the webbing.

5. The system of claim 1 wherein the inflatable section when in the inflated condition urges the belt generally inward and forward with respect to the seat.

6. The system of claim 1 further comprising a source of gas pressure connected with the inflatable section and operable to alternatively inflate and deflate the inflatable section.

7. The system of claim 1 further comprising one or more sensors in communication with the controller operative to monitor one or more vehicle conditions.

8. The system of claim 7 wherein a sensor is disposed adjacent the belt retractor to monitor movement of the belt retractor.

9. The system of claim 7 wherein a sensor is disposed adjacent a seat bottom of the vehicle seat to detect the presence of the occupant in the vehicle seat.

10. The system of claim 1 further comprising a sensor in communication with the controller provided adjacent the receiving element for sensing if the webbing is disposed adjacent the receiving element.

11. The system of claim 10 wherein the inflatable section is placed in the deflated condition upon detection of the webbing of belt assembly adjacent the receiving element.

12. A restraint system for use in a passenger seating area of a motor vehicle, the restraint system comprising:
a seat belt assembly disposed adjacent the passenger seating area adjustable between a stowed position and at least one deployed position, the seat belt assembly including a webbing positionable across the body of an occupant extending between a lower anchor mounted adjacent a lower side portion of the seat and a belt retractor disposed adjacent an upper side portion of the seat;
an inflatable section disposed within the webbing having a deflated condition and an inflated condition wherein the belt assembly is urged to the at least one deployed position;
a source of gas pressure connected with the inflatable section and operable to alternatively inflate and deflate the inflatable section;
one or more sensors operative to monitor one or more vehicle conditions;
an anchor disposed opposite the seat belt assembly adjacent the seating area having a receiving element adapted to engage and secure the belt assembly; and
a controller operative to monitor the one or more sensors,
wherein the controller instructs the source of gas pressure to inflate the inflatable section to position the belt in the at least one deployed position for securement around an occupant in a vehicle when the controller receives a signal from the one or more sensors.

13. The system of claim 12 wherein the inflatable section in the deflated condition has a generally flat cross-section, and in the inflated condition has an expanded cross-section and is more rigid than when in the deflated condition and urges the belt assembly to the at least one deployed position in which the belt is unfastened and is positioned so that the seat occupant may easily grasp the belt to permit fastening of the belt.

14. The system of claim 13 wherein the inflatable section in the inflated condition has a cross-section that is smaller than that of the surrounding webbing and is at least partially curved as it extends generally longitudinally through the webbing.

15. The system of claim 12 wherein the inflatable section when in the inflated condition urges the belt generally inward and forward with respect to the seat.

16. The system of claim 12 wherein the one or more sensors further comprises a sensor provided adjacent the receiving element for sensing if the webbing is disposed adjacent the receiving element.

17. The system of claim 16 wherein the controller instructs the source of gas pressure to place the inflatable section in the deflated condition upon detection of the webbing of belt assembly adjacent the receiving element.

18. A method of presenting a restraint system associated with a passenger seating area of a motor vehicle to an occupant, the method comprising the steps of:
providing a seat belt assembly disposed adjacent the passenger seating area including a webbing positionable across the body of an occupant extending between a lower anchor mounted adjacent a lower side portion of the seat and a belt retractor disposed adjacent an upper side portion of the seat;
providing an inflatable section disposed within the webbing adjustable between a deflated condition and an inflated condition wherein the belt assembly is urged to the at least one deployed position;
connecting a source of gas pressure to the inflatable section, the source of gas pressure operable to selectively inflate and deflate the inflatable section;
providing an anchor disposed opposite the seat belt assembly adjacent the seating area having a receiving element adapted to engage and secure the belt assembly; and
transmitting a signal from a controller to the source of gas pressure to inflate the inflatable section upon detection of an indication from at least one vehicle system.

19. The method of claim 18 further comprising the step of providing one or more sensors for detecting indications from the at least one vehicle systems.

20. The method of claim 19 further comprising the step of providing a sensor provided adjacent the receiving element for sensing if the webbing is disposed adjacent the receiving element.
